(19) United States
(12) Patent Application Publication
(10) Pub. No.: US 2011/0079316 A1
(43) Pub. Date: Apr. 7, 2011

(54) Balloon Pumping Station

(76) Inventor: Donna A. Ramere, York, SC (US)

(21) Appl. No.: 12/877,502

(22) Filed: Sep. 8, 2010

Related U.S. Application Data
(60) Provisional application No. 61/249,335, filed on Oct. 7, 2009.

(51) Int. Cl. B65B 3/12; B67D 7/42; B67D 7/60; A63H 27/10

(52) U.S. Cl. 141/10; 141/317; 141/392; 446/220

(57) ABSTRACT

Currently the only way to fill water balloons on the market is with a device that you attach to a faucet or a water hose. My invention removes the limitation of having to be near either. My inventions allows for the conservation of water. When children are using the hose or the faucet they tend to leave it running, even walking away with it running. My invention allows water balloons to be filled anywhere. The container is housed with a compression pump that allows water that has been put into the container to be forced by pressure into a tube for dispersing through a nozzle tip to the balloon that has been attached to the nozzle. There is no waste of water.

“This application claims the benefit under 35 U.S.C. 119 (e) of any U.S. provisional application(s) listed below.

Application No. 61/249,335 Filing date Oct. 7, 2009.”

### FIELD OF INVENTION

This invention related to a device and in particular a nozzle for filling balloons with water, air or a mixture of the two. In particular this device allows for the filing of the balloons without the need to connect to a water hose or other water supply. The nozzle is designed such that the balloon is held in place without the need for clamps or o-rings which can leak or be lost during use. The device consists of a chamber capable of holding water and can be pressurized by means of an integrated pump. The device also contains a valve for releasing the pressure into the balloon and a nozzle for holding the balloon on the device while it is being filled and tied.

### BACKGROUND OF THE INVENTION

Many devices are on the market for filling water balloons by means of attaching a device to a water hose or spigot (such as a kitchen sink or bathtub). As the intended user is a child, the connection tends to leak, the o-rings or other sealing mechanism can be lost, or the water can inadvertently be left on and unattended. These circumstances lead to a waste of water and possibility of a serious mess.

Additionally, the pressure for filing the balloon comes form the water pressure of the house and is generally much to high for what is necessary for filling a small rubber balloon (such as those which can be found in almost any toy store). In actuality, only a few PSI (pounds per square inch) are required to fill a balloon without risk of popping the balloon.

There is a need for a device to fill balloons with air, water or a mixture of the two which is easily operated by a young child and will not run the rick of a causing a leak or bursting the water filled balloon in the house.

### BRIEF DESCRIPTION OF THE DRAWINGS

FIG. 1 is a 3d view of the device, 10 of the instant invention showing the container 12 and the trigger 20 attached to the handle 22 and the pump head 14 and the balloon in the process of being filled 24.

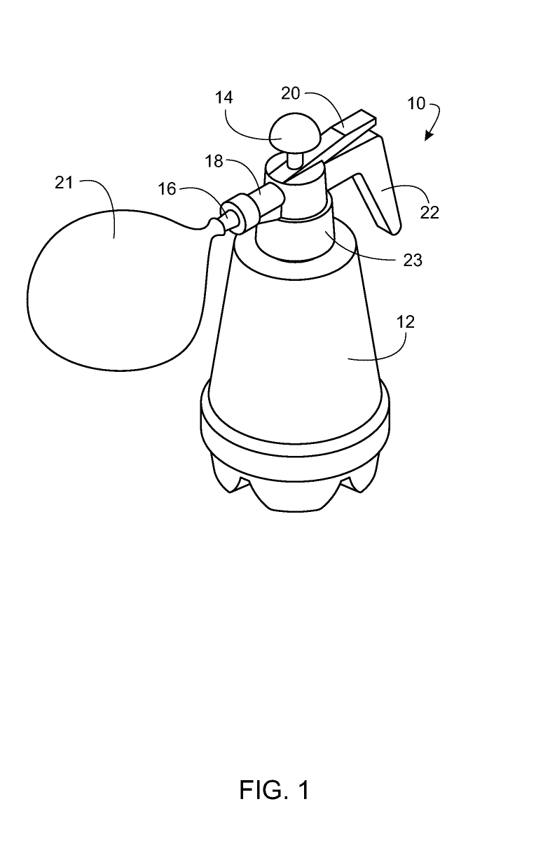

FIG. 2 is the slide view showing the nozzle 16 attached to the lid via a tube 18.

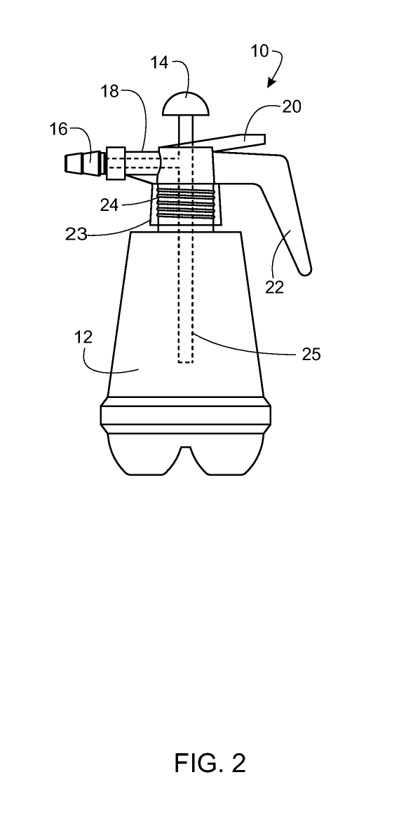

FIG. 3 show the front view of the device 10.

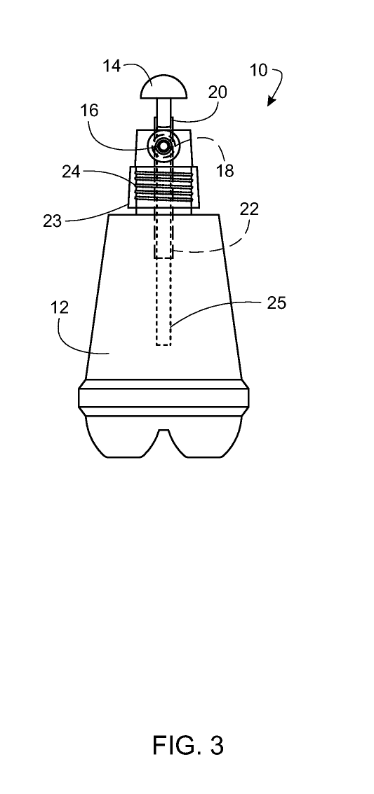

FIG. 4 shows the top view of the device 10.

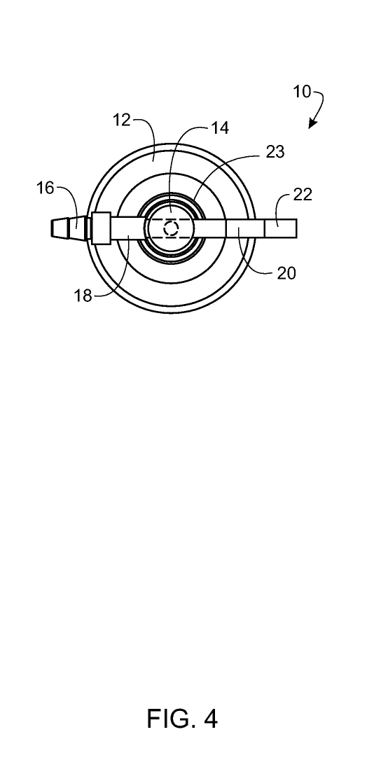

FIG. 5 shows the lid and container are threads for attaching the two.

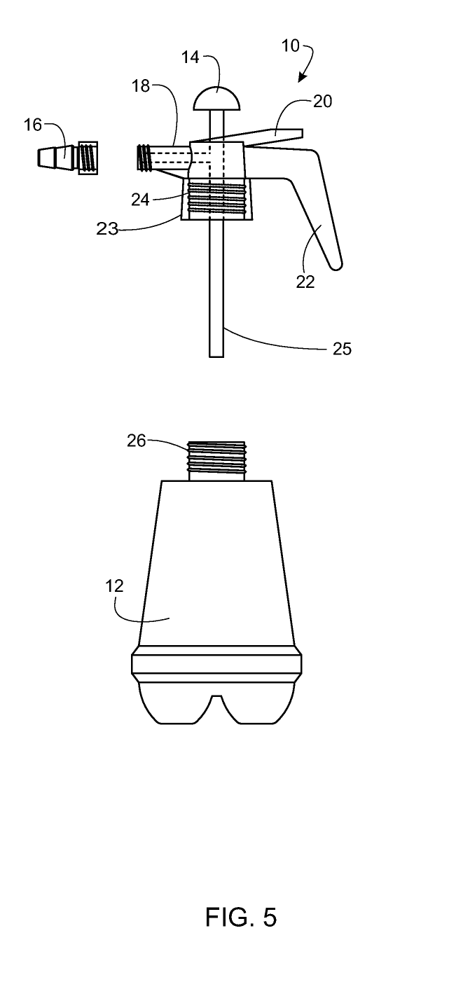

FIG. 6 show the nozzle before being attached to the device.

FIG. 7 shows the device with an external pick-up tube (31) for delivery of the fluid to the valve and ultimately to the nozzle.

### DETAILED DESCRIPTION OF THE INVENTION

The device as shown and described in the following pages consists of a number of mechanisms which can be easily operated by a child without the need for adult supervision. The container 12 is made of a plastic and capable of holding water and pressure up to about 30 PSI. For purposes of this invention the plastics can be polyethylene, polypropylene, polyethylene terthalate (PET), polycarbonate, or any similar material. In one embodiment of this invention the container is made of PET or polycarbonate.

One particular important embodiment of this invention is that the device can be used without the need for a pressurized water source. The device can be filled from a bucket, swimming pool or bottle and does not require a hose or sink for operation. This is important when the balloons are being filled with water and used outside, such as a park or beach.

The container 12 is attached to the lid 23 which contains the pumping mechanism 25 with the pump handle 14 and the trigger mechanism 20, and the nozzle 16 for holding the balloon. Additionally, the lid will have a handle 22 for ease of operation and handling. The lid can be made of the same plastic as the container or a different material. The lid contains a series of male or female screw thread 24 which will match, in the opposite configuration, the screw threads of the container 26. When the male and female screw threads of the lid and the containers are engaged with each other, they will form a pressure resistant seal capable of holding the operating pressure (about 30 PSI). In one embodiment of this invention the lid will contain a gasket or o-ring for enhancing the seal between the lid and containing. In another embodiment the lid will contain a molded seal for contacting the container and will not need a separate o-ring.

The pump mechanism 25 contained in the lid 23 will be actuated by a repeated motion of the mechanism by the operator and will contain a one way valve such that the pressure applied to the container does not flow back into the pump mechanism. Such one way valves are well known in the art and are typically made of a flap of rubber which will allow the pumped fluid to flow out of the pump body, but not in the reverse direction. The building pressure in the container will act to seal the one way valve and prevent the backflow of any fluid. For the purposes of this application, fluid is defined as any flowable material, such as air or water.

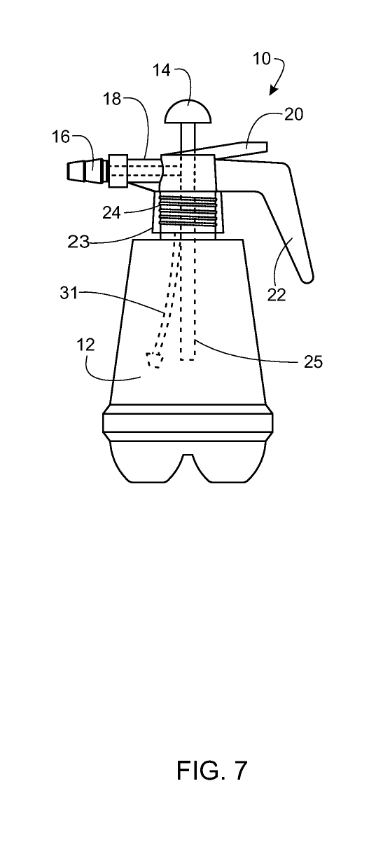

In one embodiment of this invention a separate tube (FIGS. 7, 31) can be utilized to direct the liquid to the valve and then subsequently to the nozzle. In a separate embodiment, the tube to the nozzle can be internally located in the pump mechanism, 25 and will serve the same purpose.

Included in the lid is a trigger mechanism 20 for allowing the flow of the liquid (air or water) from the container 12 through a nozzle 16 and into the attached balloon 24. The trigger mechanism can be any usual manually actuated valve, such as a piston, slide or gate type valve. In one embodiment the valve is operated by the thumb and the mechanism is located just above the handle. The output of the trigger is connected to the nozzle by means of a tube 18 or channel in the lid. The nozzle can be connected directly to the output side of the trigger mechanism. The inlet of the trigger is connected a tube or channel in the pump mechanism. The tube or channel can be at the top of the container for filling the balloon with air, at the bottom of the container for filling the balloon with water, of any combination thereof.

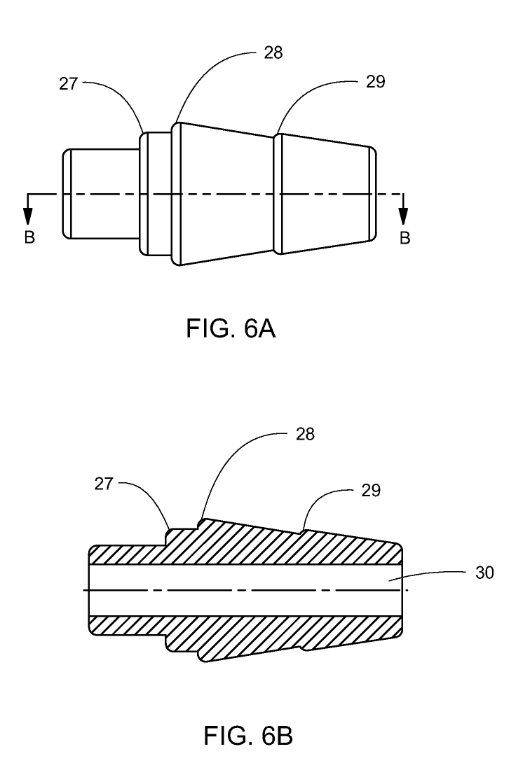

The nozzle serves multiple functions, one of which is to hold the balloon without any additional clips or the need for the user to keep their fingers on the balloon. The nozzle also allows for the balloon to be filled with the fluid in the container. The dimensions of the nozzle and the ridges for holding the balloon are shown in FIG. 6. In one embodiment the nozzle will contain three (3) ridges. The inner ridge 27 and outer ridge 29 will have a diameter of 0.480 inches and the middle ridge 28 will have a diameter of 0.570 inches. In an other embodiment of this invention, the outer tip will have a diameter of 0.360 inches and will gently tapper up to the outer ridge for easy insertion and removal of the balloon. The nozzle will be 1.224 inches long and have an inner diameter of 0.203 inches. For purposes of this invention, the outer ridge is defined as the ridge furthest away from the container and the inner ridge is the one closest to the container.

The position and size of the ridges are specific to each type of balloon. In one embodiment of this invention the balloon is to have the middle ridge larger than the inner or outer ridge. The outer ridge is designed for holding 3 inch diameter balloons with out the need for clips or for the operator to hold the balloon on with his fingers. The middle and inner ridge, working together in concert, will hold bigger balloons up to an including 9 inch diameter balloons. The nozzle is designed to handle a large number and different types of balloons sold commercially today.

The balloon can be removed from the nozzle before or after tying the balloon closed. In one embodiment of this invention the balloon is tied closed with a piece of string or yarn. In another embodiment, the balloon is removed from the nozzle before the end of the balloon is tied closed.

What I claim:

1. A balloon filling device comprising a container for holding a fluid, a pump mechanism for pressurizing the container, a trigger mechanism for controlling the flow of the fluid and a nozzle for attaching and holding a balloon while it is being filled with the fluid.

2. The device of claim 1, wherein the container is sealed with a lid which is attached via a threaded mechanism.

3. The lid of claim 2, wherein the lid contains the pump, the trigger and the nozzle.

4. The device of claim 1, the fluid is water, air of a mixture thereof.

5. The device of claim 1, wherein the nozzle is 1.224 inches long and 0.570 inches wide, having three ridges and an inner opening of 0.203 inches.

6. A method for filing a balloon using the device of claim 1 consisting of;
i. filing the container with the fluid;
ii. sealing the container,
iii. pressurizing the container with the pump;
iv. attaching the balloon to the nozzle;
v. actuating the trigger to fill the balloon and
vi. sealing the balloon with a string.

7. The method of claim 6, wherein the fluid is air or water.

8. A nozzle containing an inner ridge, a middle ridge and an outer ridge for holding a balloon while it is being inflated.

9. The nozzle of claim 8, wherein the middle ridge is larger than the inner or outer ridge.

10. The nozzle of claim 8, wherein the inner and the outer ridge are 0.480 inches in diameter.

11. The nozzle of claim 8, wherein the middle ridge is 0.570 inches in diameter.

12. The balloon of claim 8, wherein the balloon is from about 3 inches to about 9 inches in diameter.

13. The balloon of claim 8, wherein the balloon is from about 3 inches to about 5 inches in diameter.

14. The nozzle of claim 9 wherein the nozzle is designed to hold the balloon without the need for clamps while the balloon is being inflated and tied.

15. The devise of claim 1, with an additional external pick-up tube for delivery of the fluid to the valve and ultimately to the nozzle.

16. The devise of claim 1, whereby an additional tube to the nozzle for delivery of the fluid is internally located in the pump mechanism.
